(19) United States
(12) Patent Application Publication
(10) Pub. No.: US 2017/0103132 A1
(43) Pub. Date: Apr. 13, 2017

(54) IDENTIFYING SEARCH RESULTS FROM LOCAL AND REMOTE SEARCH OF COMMUNICATIONS IN PARALLEL

(71) Applicant: MICROSOFT TECHNOLOGY LICENSING, LLC, Redmond, WA (US)

(72) Inventors: Jeffrey Wall, Redmond, WA (US); Kent Mai, Redmond, WA (US); Marius Constantin, Bellevue, WA (US)

(21) Appl. No.: 15/045,350

(22) Filed: Feb. 17, 2016

Related U.S. Application Data
(60) Provisional application No. 62/239,964, filed on Oct. 11, 2015.

(51) Int. Cl. G06F 17/30; H04L 12/24; G06N 99/00

(52) U.S. Cl. CPC G06F 17/30867; G06F 17/30554; G06F 17/3087; G06F 17/3053; G06N 99/005; H04L 41/0631

(57) ABSTRACT

Identifying search results from a local and remote search of communications in parallel may be provided. In some examples, an application, such as a communication application, may facilitate an exchange of the communications with a server. A request may be received to perform a search within the exchanged communications. A connection to a server may be verified. A remote search request may be submitted within remotely stored communications based on the received request to the server. The local search may be initiated within locally stored communications. Search results may be displayed through a communication interface. The search results are based on the remote search request and the local search.

### CROSS-REFERENCE TO RELATED APPLICATION

This Application claims priority under 35 U.S.C. §119(e) to U.S. Provisional Patent Application Ser. No. 62/239,964 filed on Oct. 11, 2015. The disclosure of the U.S. Provisional Patent Application is hereby incorporated by reference in its entirety.

### BACKGROUND

Wireless devices have become increasingly popular in the transmission of business and personal communications. Users may wish to search for a specific communication (e.g., an email, a data file, a graphical file, or a media file) locally on the wireless device or remotely on an associated tile server. However, performing remote searches on the wireless device may result in a communication lag, as the wireless device sends the search terms to the file server, where the file server then performs the search, and then the file server subsequently sends the search terms back to the wireless device. The time from initiation of the search on the wireless device to the receipt of the search results by the wireless device may be greater than desired.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to identifying search results from a local and remote search of communications in parallel. In some examples, an application, such as a communication application, may facilitate an exchange of the communications with a server. A request to perform a search within the exchanged communications may be received. Next, a connection to the server may be verified. In response, a remote search request may be submitted within remotely stored communications based on the received request to the server. A local search may be initiated within locally stored communications. Then, search results may be displayed through a communication interface. The search results may be based on the remote search request and the local search.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example computing environment for identifying search results from a local and remote search of communications in parallel, according to embodiments;

FIG. 2 is a display diagram illustrating example displayed communications associated with search results identified from a local and remote search of communications in parallel, according to embodiments;

FIG. 3 is a display diagram illustrating local and remote search results identified from a local and remote search of communications in parallel, according to embodiments;

FIG. 4A is a display diagram illustrating refinement suggestions identified in from a local and remote search of communications in parallel, according to embodiments;

FIG. 4B is a display diagram illustrating participant-defined refinement of search results identified from a local and remote search of communications in parallel, according to embodiments;

FIG. 5 is a simplified networked environment, where a system according to embodiments may be implemented;

FIG. 6 is a block diagram of an example computing device, which may be used for identifying search results from a local and remote search of communications in parallel, according, to embodiments; and

FIG. 7 is a logic flow diagram illustrating a process for identifying search results from a local and remote search of communications in parallel, according to embodiments.

### DETAILED DESCRIPTION

As briefly described above, identifying search results from a local and remote search of communications in parallel may be provided. In some examples, an application, such as a communication application, may facilitate an exchange of the communications with a server. A request to perform a search within the exchanged communications may be received. Next, a connection to the server may be verified. In response, a remote search request may be submitted within remotely stored communications based on the received request to the server. A local search may be initiated within locally stored communications. Then, search results may be displayed through a communication interface. The search results may be based on the remote search request and the local search.

The communication application may receive a selection of the search results. The communications associated with die search results may be displayed on the communication interface. The search results may include a calendar invite, a personal email address of a participant, a professional email address of the participant, an attachment, a task item, a group conversation thread, and/or a folder, among other examples. In some examples, the communication application may identify attributes associated with the search results. The attributes may include a priority, a subject matter, and/or a time stamp, among other examples. The attributes may be displayed on the communication interface. The attributes may be distinguished from the search results with a textual scheme, a coloring scheme, a shading scheme, and/or a graphical element, among other schemes.

In the following detailed description, references are made to the accompanying drawings that form a part hereof, and in which are shown by way of illustrations, specific embodiments, or examples. These aspects may be combined, other aspects may be utilized, and structural changes may be made without departing, from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network, in a distributed computing environment, program modules may be located in both local and remote memory storage devices.

Some embodiments may be implemented as a computer-implemented process (method), a computing, system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of to volatile computer memory, a non-volatile memory, a hard drive, a flash drive, a floppy disk, or a compact disk, and comparable hardware media.

Throughout this specification, the term “platform” may be a combination of software and hardware components for identifying search results from a local and remote search of communications in parallel. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and one or more processors that includes a server, a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. Actions or operations described herein may be executed on a single processor, on multiple processors (in a single machine or distributed over multiple machines), or on one or more cores of a multi-core processor. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that allow the application or service to interact or communicate with one or more other applications and services managed by separate entities.

While example implementations are described using communications herein, embodiments are not limited to communications. Identifying search results from a local and remote search of communications in parallel may be implemented in other environments, such as instant messages, data sharing, application sharing, online conferencing, and similar communications, where data may be exchanged.

The technical advantages of identifying search results from a local and remote search of communications in parallel may include, among others, enhanced participant efficiency in communication exchange. Additionally, processing and network bandwidth usage may be reduced with use of a hybrid combination of local and remote searches. Further, participant interaction may be improved by allowing recipients to receive faster, more accurate, and enhanced search results.

Embodiments address a need that arises from very large scale of operations created by networked computing and cloud based services that cannot be managed by humans. The actions/operations described herein are not a mere use of a computer, but address results of a system that is a direct consequence of software used as a service such as communication services offered in conjunction with communications.

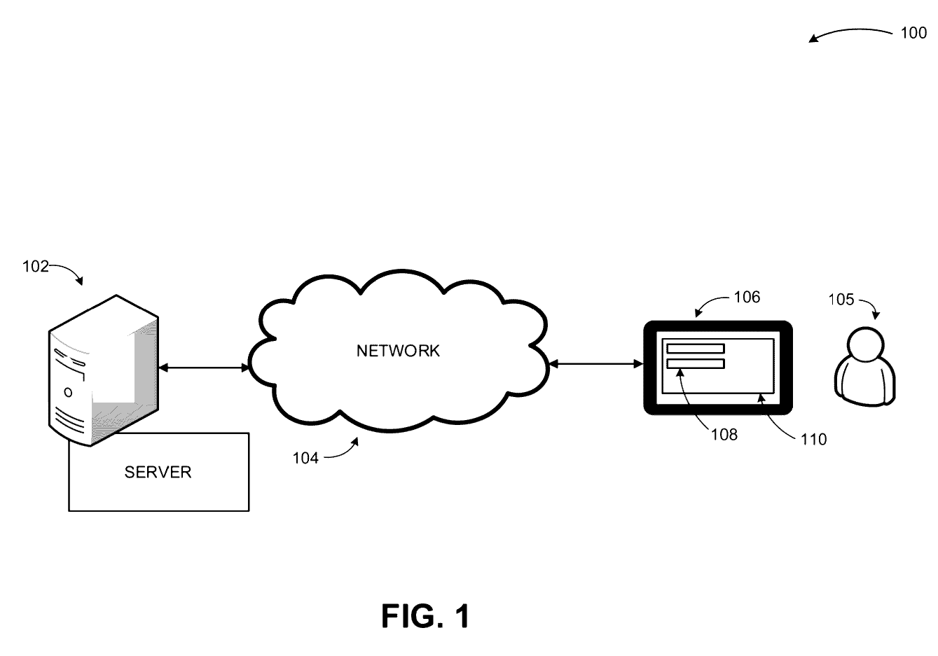

FIG. 1 is a conceptual diagram illustrating an example computing environment for identifying search results from a local and remote search of communications in parallel, according to embodiments.

As shown in a diagram 100, a computing device 106 may execute a communication application 108. The computing device 106 may include a display device, such as a touch enabled display component, and a monitor, among others, to provide the communication application 108 to a participant 105. The computing device 106 may include a desktop computer, a laptop computer, a tablet, a handheld device, a vehicle mount computer, an embedded computer system, a smart phone, and a wearable computer, among other similar computing devices, for example.

In some examples, the communication application 108 may be executed on a server 102. The server 102 may include a web server or a document server, among others. The computing device 106 (e.g., a local system) may communicate with the server 102 (a remote system) through a network 104. The network 104 may provide wired or wireless communications between nodes, such as the computing device 106 or the server 102.

In other examples, the communication application 108 may be provided by a third party service (e.g., a communication service or a search service), web applications, and/or a datacenter, among others. Local access to the communication application 108 may be provided by locally installed rich clients (e.g., a local version of the communication application 108) or generic applications, such as a browser on the computing device 106.

The communication application 108 may facilitate an exchange of communications with the server 102. The communications may include emails, online calendar invites, attachments associated with the emails, and/or text messages, among others. In examples, the communication application 108 may receive a request (e.g., a query) to perform a search within the exchanged communications.

In some examples, the communication application 108 may verify a connection to the server 102. In response to the verification of the connection the server 102, the communication application 108 may submit a remote server-side) search request within remotely stored communications based on the received request to the server 102. In other examples, the communication application 108 may utilize a search engine to perform the remote search request within the remotely stored communications based on the received request to the server 102 and may initiate the local search within locally stored communications in parallel. In response, the communication application 108 may display the search results through a communication interface 110. The search results may include suggestions and may be based on the remote search request and the local search. The search results may include a calendar invite, a personal email address of a participant 105, a professional email address of the participant 105, an attachment, a task item, a group conversation thread, and/or a folder, among others.

In some examples, the communication application 108 may receive, from the participant 105, a selection of a subset of the search results. In response to the selection of the subset of the search results, the communications associated with the selection of the subset of the search results may be displayed on the communication interface 110.

In other embodiments, the communication application 108 may detect a failure to connect to the server 102. The communication application 108 may prohibit an initiation of the remote search request within the remotely stored communications based on the received request to the server 102. The search results may be displayed through the communication interface 110. The search results may be based on the local search.

While the example system in FIG. 1 has been described with specific components including the computing device 106, the communication application 108, and the server 102, embodiments are not limited to these components or system configurations and can be implemented with other system configuration employing fewer or additional components.

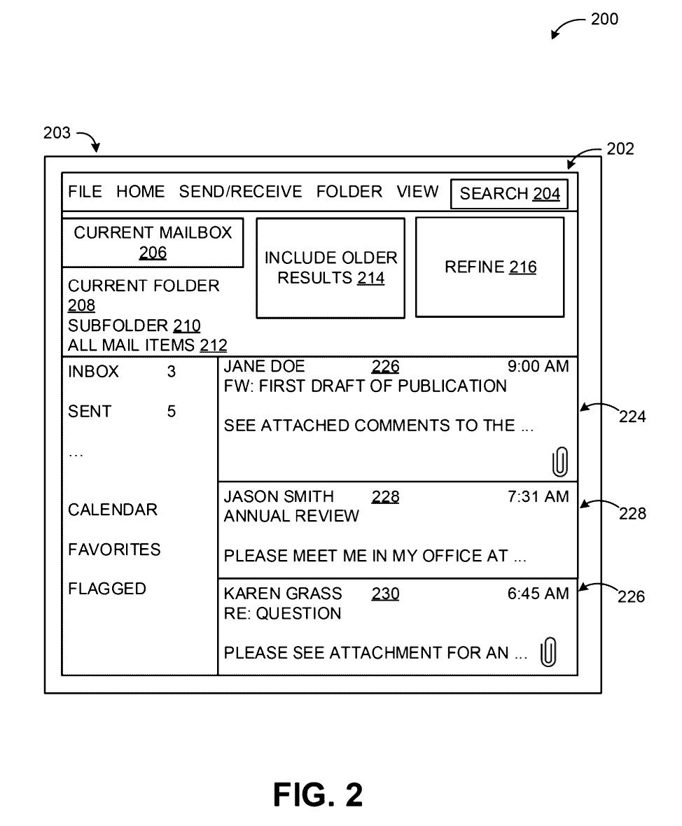

FIG. 2 is a display diagram illustrating example displayed communications associated with search results identified from a local and remote search of communications in parallel, according to embodiments.

As shown in a diagram 200, a computing device may execute a communication application 203. The communication application 203 may include a processing engine and a search engine. As previously disclosed, the communication application 203 may present search results through a communication interface 202. The search results may be based on the remote search request and/or the local search.

In some examples, the communication application 203 may receive, from a participant, a selection of a subset of the search results. In response to the selection of the subset of the search results, the communications associated with the selection of the subset of the search results (e.g., a communication 226 of communications 226, 228, 230) may be displayed on the communication interface 202.

The communication interface 202 may additionally present graphical components to allow the participant to interact with the communications 226, 228, 230. The graphical components may include, among others, a current folder graphical component 208 (e.g., an inbox folder, a sent folder, an archive folder, etc.), a current mailbox graphical component 206, a subfolder graphical component 210, an all mail items graphical component 212 (e.g., an entirety of the current mailbox), a graphical component to include older results 214 based on a timestamp associated with the search results, a search graphical component 204, and a refinement graphical component 216. Additional graphical components may allow the participant to modify the search results and/or the communications on the communication interface 202.

In an example, communication application 203 may receive, from the participant, an input action executed on the current folder graphical component 208. The input action may include, among others, a touch input, a gesture input, a voice command, an eye tracking input, a gyroscopic input, a pen input, a mouse input, and/or keyboard input, among others. In response, the communication application 203 may display the communications (e.g., the communication 328) associated with the current folder an inbox, a sent folder, etc.).

Similarly, in other examples, the communication application 203 may receive, from the participant, the input action executed on the current mailbox graphical component 206, the subfolder graphical component 210, the all mail items graphical component 212, or the graphical component to include older results 214, among other graphical components. In response, the communication application 203 may display the communications (e.g., the communication 226, the communication 228, and/or the communication 230) associated with the selection.

In other embodiments, the communication application 203 may receive the input action executed on the search graphical component 204 to search the displayed communications. In further embodiments, the communication application 203 may receive the input action executed on the refinement graphical component 216 to modify the displayed communications. These examples are not limited to the operations disclosed herein.

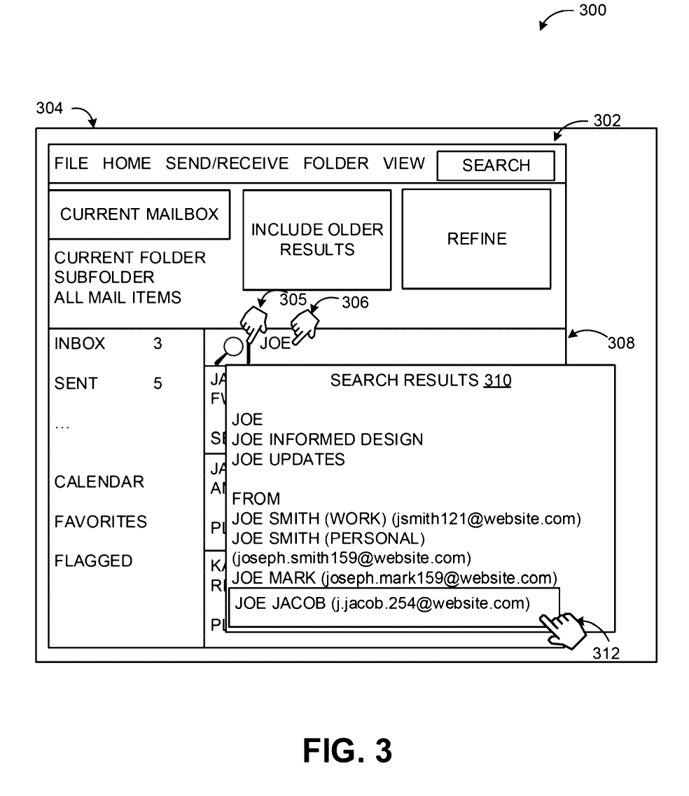

FIG. 3 is a display diagram illustrating local and remote search results identified from a local and remote search of communications in parallel, according to embodiments.

As shown in a diagram 300, a computing device may execute a communication application 303. In an example, a search engine of the communication application 303 may detect a gesture 305 (e.g., a quick action, a tap action, a swipe action, and a press and hold action, etc.) executed in a participant entry field 308 on a communication interface 302. In response to the execution of the gesture 305, historical search results may populate the participant entry field 308. In some examples, the historical search results may be displayed on a drop-down menu, a textual entry box, or a graphical control element, among others. The historical search results may include suggestions generated from previous search results. For example, the historical search results may include previous local search results and/or previous remote search results identified from implementation of an intelligent learning algorithm and/or a machine learning algorithm during a previous time period. The communication application 303 may receive a selection from the historical search results. In response to the selection, the communication associated with the selected, historical search results may be displayed on the communication interface 302.

In other examples, the communication application 303 may fail to receive the selection from the historical search results. The communication application 303 may, alternatively, receive an input action 306 in the participant entry field 308 on the communication interface 302. For example, the participant may enter the input action 306 “JOE” into the participant entry field 318. Search results 320 may be displayed on the communication interface 302. The search results 320 may be based on the remote search request and/or the local search performed in parallel by the communication application 303. In other examples, the remote search request and the local search may be performed at differing time periods.

Examples of the search results 320 may include a personal email address of another participant (e.g., Joe Smith's professional email address, jsmith121@website.com), a calendar invite (e.g., a meeting associated with a colleague, Joe Mark), a personal email address of another participant (e.g., Joe Smith's personal email address, joseph.smith159@website.com), a professional attachment (e.g., a file attachment for an upcoming meeting), etc. The participant may execute a selection 312 of the search results 320. In response, the communications associated with the selected search results 320 may be displayed in the communication interface 302.

In some examples, the search engine may additionally identify attributes associated with the search results 320. The attributes may include a priority, a subject matter, a recipient, a sender, and/or a time stamp, among others. The attributes may be displayed on the communication interface 302. A scheme (e.g., a textual scheme, a coloring scheme, a shading scheme, and/or a graphical element, among others) may be used to distinguish the attributes from the search results 320.

In additional examples, the search engine may identify the attributes associated with the local search results and the attributes associated with the remote search results. The search engine may identify a first priority attribute (e.g., a high priority) associated with the local search results and may identify a second priority attribute (e.g., a low priority) associated with remote search results. The search engine may assign a first weighted value (e.g., a weighted value of three) to the first priority attribute and may assign a second weighed value (e.g., a weighted value of one) to the second priority attribute. The search engine may compare the first weighted value to the second weighed value.

In response to detecting the first weighted value (e.g., a weighted value of three) as being greater than the second weighted value (e.g., a weighted value of one), the search engine may order the local search results prior to the remote search results. The local search results may be ordered and/or prioritized in one of a chronologically descending or ascending order with respect to the remote search results.

In another example, in response to detecting the second weighted value as being greater than the first weighted value, the search engine may order the remote search results prior to the local search results. The remote search results may be ordered and/or prioritized in one of a chronologically descending or ascending order with respect to the local search results.

In additional examples, the search results 320 may be ordered and/or prioritized based on one or more intelligent learning algorithms and/or machine learning algorithms. For example, an intelligent learning algorithm may analyze a history of assigned weighted values associated with attributes associated with the search results 320 during a first time period to determine the associated weighted values during a second time period.

In other embodiments, the search engine may detect a failure to connect to the server. In other examples, the search engine may detect a failure of the server to respond in a predetermined amount of time (e.g., in an hour, in two hours, or in twenty four hours, etc.) determined by default rules or participant-defined rules, the search engine may prohibit an initiation of the remote search request within the remotely stored communications based on the received request to the server. The search engine may display the local search results through the communication interface 302.

Alternatively, if the search engine detects a failure to connect to the server, the search engine may implement an intelligent learning algorithm to identify a previous search of the locally stored communications during another time period. The previous search may share a keyword, a syntax modifier, and/or a portion of the keyword with the local search during a previous time period. Previous search results associated with the previous search may be identified during a subsequent time period. The previous search results may be presented with the search results on the communication interface 302.

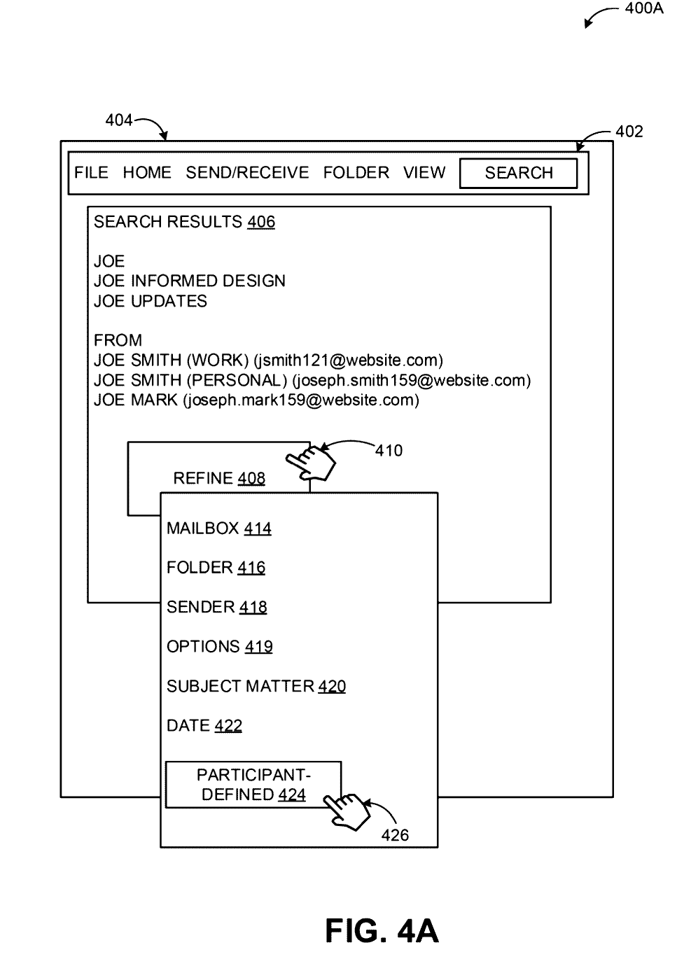

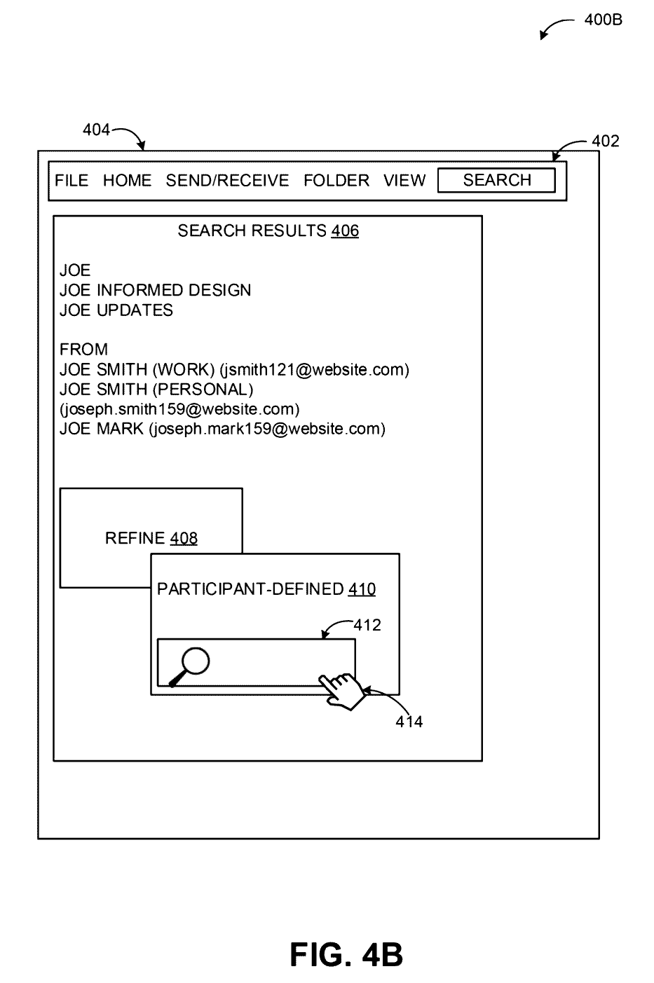

FIG. 4A is a display diagram illustrating refinement suggestions identified from a local and remote search of communications in parallel, according to embodiments.

As shown in a diagram 400A, a computing device may execute a communication application 404. Search results 406 may be displayed on a communication interface 402 of the communication application 404. In some examples, a search engine of the communication application 404 may receive a refinement request 410, from a participant, to refine 408 the search results 406 to limit the search results 406 to local search results and/or remote search results.

In other examples, the search engine may receive the refinement request 410, from the participant, to restrict the search results 406 to a mailbox 414 associated with the search results 406 (e.g., jmsmith121@website.com, joseph.mark159@website.com, etc.), a folder 416 associated with the search results 406 (e.g., an inbox folder, a sent folder, an archive folder, a spam folder, etc.), a sender 418 associated with the search results 406 (e.g., Joe Smith, Joe Mark, Joe Frank, etc.), options 419 associated with the search results 406 (e.g., a graphic attachment, a video attachment, etc.), a subject matter 420 associated with the search results 406 (e.g., a work project, a personal matter, etc.), a date 422 associated with the search results 406 (e.g., older than an hour, older than a week, older than a month, older than a year, etc.) and identified by a time stamp and associated with the search results 406, and/or a participant-defined attribute 424 associated with the search results 406, etc. In further examples, the search engine of the communication application 404 may detect an input action 426 executed on the participant defined attribute 424 associated with the search results 406.

In additional embodiments, the search engine may identify a credential (e.g., a managerial credential, a permission to edit, etc.) associated with the participant. In response to the request from the participant, the search engine may compare the credential to a predefined rule. In some examples, the search engine may detect a match between the credential and the predefined rule. In response, the search engine may submit another remote search request within the remotely stored communications based on the refinement request 410 and may initiate another local search within the locally stored communications. The search results 406 may be replaced with a new set of search results 406. The new set of search results 406 may be displayed through the communication interface 402.

In another example, the search engine may detect a mismatch between the credential (e.g., a read-only credential) and the predefined rule. In response, the search engine may display a notification to the participant on the communication interface 402 of a failure to initiate another remote search request within the remotely stored communications and a failure to initiate another local search within the locally stored communications.

FIG. 4B is a display diagram illustrating participant-defined refinement of search results identified from a local and remote search of communications in parallel, according to embodiments.

As shown in a diagram 400B, a computing device may execute a communication application 404. Search results 406 may be displayed on a communication interface 402 of the communication application 404. In some examples, a search engine of the communication application 404 may receive a refinement request 408, from a participant, to refine the search results 406. The search engine may detect an input action 414 executed in an entry field 412 on the participant-defined attribute 410 associated with the search results 406. The refinement request 408 may include a keyword, a personal email address, a professional email address, a meeting, a conversation thread, a task item, a syntax modifier, a portion of a keyword, and a priority level, etc. The refinement request 408 is not limited to the examples disclosed herein. As disclosed previously, the search engine may then identify a credential associated with the participant to determine if the refinement operation may be executed.

The example scenarios and schemas in FIG. 1 through FIG. 4B are shown with specific components, data types, and configurations. Embodiments are not limited to systems according to these example configurations. Identifying search results from a local and remote search of communications in parallel may be implemented in configurations employing fewer or additional components in applications and user interfaces. Furthermore, the example schema and components shown in FIG. 1 through FIG. 4 and their subcomponents may be implemented in a similar manner with other values using the principles described herein.

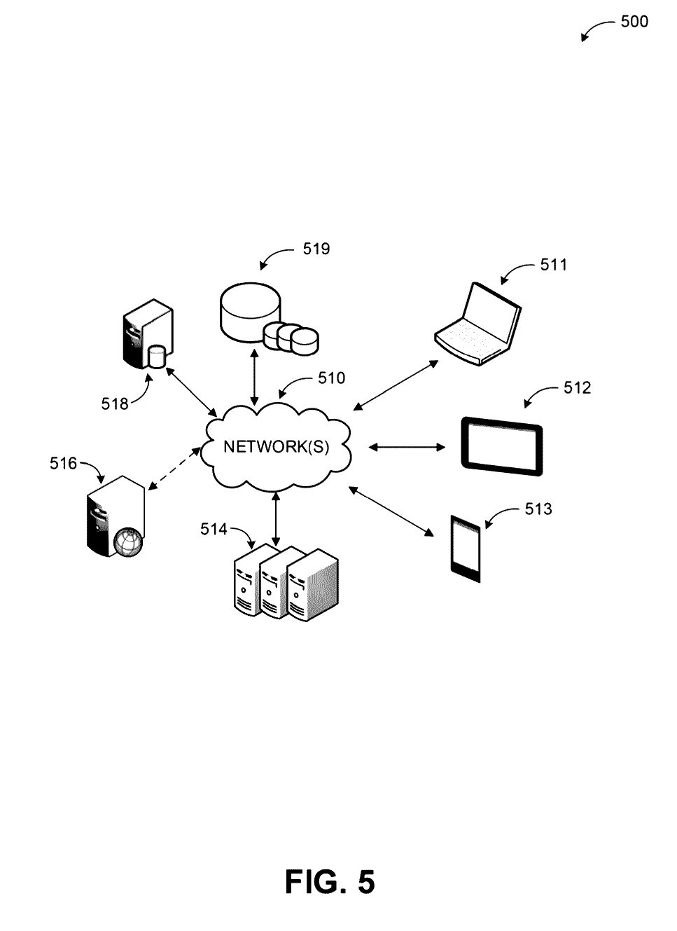

FIG. 5 is a simplified networked environment, where a system according to embodiments may be implemented.

As shown a diagram 500, search results may be identified and displayed on a communication interface of a computing device. The computing device may execute a communication application. In examples, a communication service may be implemented via software executed over the servers 514. The platform may communicate with client applications on individual computing devices such as a smart phone 513, a mobile computer 512, or desktop computer 511 (client devices') through network(s) 510. The servers 514 may include one or more communication servers 516, where at least one of the one or more communication servers 516 may be configured to execute one or more applications (i.e. the communication application) associated with a communication service.

In other examples, the communication service may be provided by a third party service or may include a web application. The communication service may store data associated with data in a data store 519 directly or through a database server 518. Client applications executed on client devices 511-513 may be enabled to receive the data and render the communication interface displaying information associated with captured communications.

Client applications executed on any of the client devices 511-513 may facilitate communications via application(s) executed by the one or more communication servers 516, or on an individual communication server. An application, such as the communication application, may facilitate an exchange of the communications with a server. The communication application may receive a request to perform a search within the exchanged communications. A verification of a connection to a server may be performed. In response to the verification of the connection to the server, the communication application may submit a remote search request within remotely stored communications based on the received request to the server. Additionally, the communication application may initiate the local search within locally stored communications. Search results may be displayed through a communication interface. The search results may be based on the remote search request and/or the local search. The communication application may store the data associated with the search results in the data store 519 directly or through database server 518.

The network(s) 510 may comprise any topology of servers, clients. Internet service providers, and communication media. A system according to embodiments may have a static or dynamic topology. The network(s) 510 may include secure networks such as an enterprise network, an unsecure network such as a wireless open network, or the Internet. The network(s) 510 may also coordinate communication over other networks such as Public Switched Telephone Network (PSTN) or cellular networks. Furthermore, the network(s) 510 may include short range wireless networks such as Bluetooth or similar ones. The network(s) 510 provide communication between the nodes described herein. By way of example, and not limitation, the network(s) 510 may include wireless media such as acoustic, RF, infrared and other wireless media.

A textual scheme, a graphical scheme, an audio scheme, an animation scheme, a coloring scheme, a highlighting scheme, and/or a shading scheme may be employed to distinguish local search results from remote search results. Additionally, the schemes may be employed to distinguish attributes associated with the local search results from attributes associated with the remote search results.

Many other configurations of computing devices, applications, data sources, and data distribution systems may be employed for identifying search results from a local and remote search of communications in parallel. Furthermore, the networked environments discussed in FIG. 5 are for illustration purposes only. Embodiments are not limited to the example applications, modules, or processes.

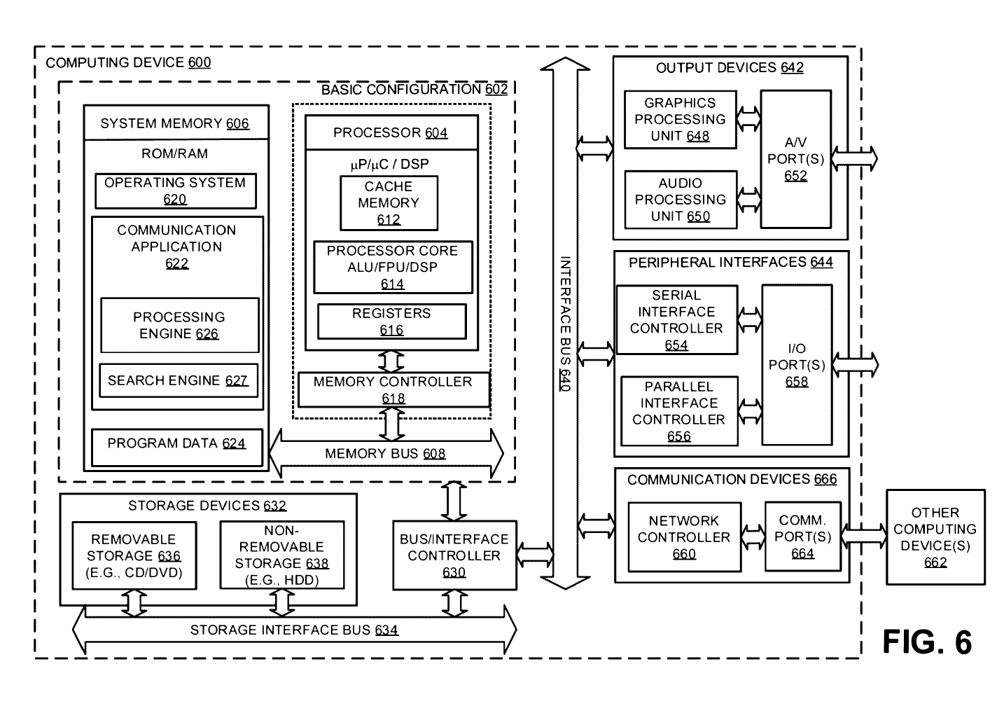

FIG. 6 is a block diagram of an example computing device, which may be used for identifying search results from a local and remote search of communications in parallel, according to embodiments.

For example, a computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The example basic configuration 602 may be illustrated in FIG. 5 by those components within the inner dashed line.

Depending on the desired configuration, the processor 704 may be of any type, including but not limited to a microprocessor (μP), a microcontroller (μC), a digital signal processor (DSP), or any combination thereof. The processor 604 may include one more levels of caching, such as a level cache memory 612, one or more processor cores 614, and registers 616. The one or more processor cores 614 may (each) include an arithmetic logic unit (ALU), a floating point unit (FPU), a digital signal processing core (DSP Core), or any combination thereof. An example memory controller 618 may also be used with the processor 604, or in some implementations, the example memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a communication application 622, and a program data 624. The communication application 622 may include a processing, engine 626 and a search engine 627. The processing engine 626 may facilitate an exchange of the communications with a server. The search engine 627 may receive a request to perform a search within the exchanged communications. The search engine 627 may, in response to a verification of a connection to the server, submit a remote search request within remotely stored communications based on the received request to the server and may initiate the local search within locally stored communications. The search engine 627 may display search results through a communication interface. The search results may be based on the remote search request and the local search. The program data 624 may also include, among other data, communication data, search result data, attribute data, and other information data related to the search results or the like, as described herein.

The computing device 600 may have additional features or functionality, and additional interfaces to facilitate communications between the example basic configuration 602 and any desired devices and interfaces. For example, a bus/interface controller 630 may be used to facilitate communications between the example basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name as few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 646) to the example basic configuration 602 via the bus/interface controller 630. Some of the one or more output devices 642 include a graphics processing unit 648 and an audio processing unit 650, which may be configured to communicate to various external devices such as a display or speakers via one or more A/V ports 652. The one or more peripheral interfaces 644 may include a serial interface controller 654 or a parallel interlace controller 656, which may be configured to communicate with external devices such as input devices (for example, keyboard, mouse, pen, voice input device, touch input device, etc.) or other peripheral devices (for example, printer, scanner, etc.) via one or more I/O ports 658. An example communication device 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods for identifying search results from a local and remote search of communications in parallel. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

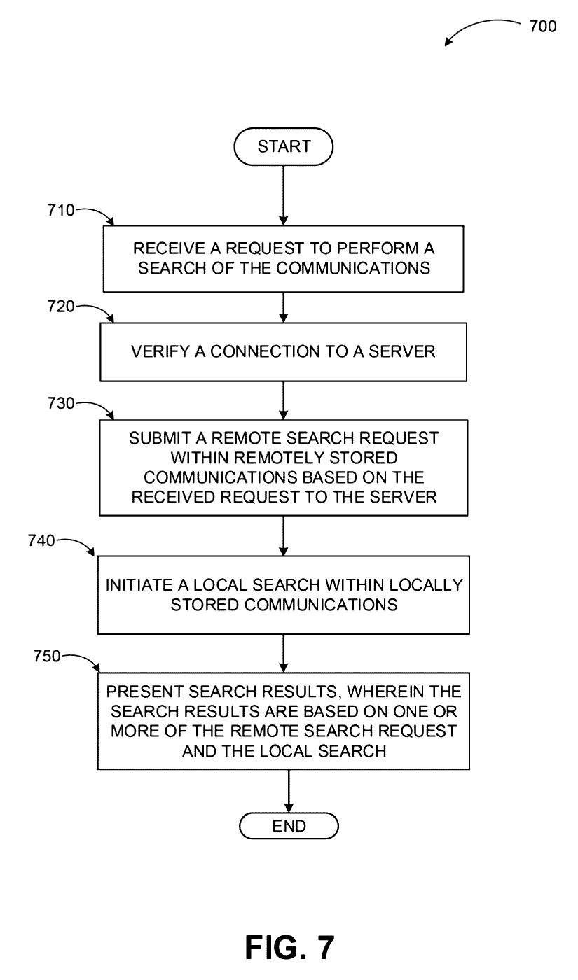

FIG. 7 is a logic flow diagram illustrating a process for identifying search results from a local and remote search of communications in parallel, according to embodiments.

A process 700 may be implemented on a computing device, such as the computing device 600, or with another system. As described, a participant may be allowed to interact with a communication application through an input device or a touch enabled display component of the computing device 600. The computing device 600 may provide a communication interface of the communication application to the participant.

The process 700 begins with operation 710, where the communication application may receive a request to perform a search within the exchanged communications. At operation 720, the communication application may verify a connection to a server. In some examples, the communication application may detect a failure to connect to the server. In some examples, the server may not respond in a predetermined amount of time determined by default rules or participant-defined rules.

At operation 730, the communication application may submit a remote search request within remotely stored communications based the received request to the server. In response to the detection of the failure to connect to the server, the communication application may prohibit an initiation of the remote search request within the remotely stored communications based on the received request to the server and the communication application may display the search results through the communication interface. At operation 740, the communication application may initiate the local search within locally stored communications.

At operation 750, the communication application may display search results through a communication interface. The search results are based on the remote search request and/or the local search. The search results may include a calendar invite, a personal email address of a participant, a professional email address of the participant, an attachment, a task item, a group conversation thread, and/or a folder. In some examples, the search results may identify attributes associated with the search results. The attributes may include a priority, a subject matter, and a time stamp. The attributes may be displayed on the communication interface. Schemes may be employed to distinguish the attributes from the search results.

The operations included in process 700 are for illustration purposes. Identifying search results from a local and remote search of communications in parallel may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

According to some embodiments, a means for identifying search results from a local and remote search of communications may be described, which may include a means for facilitating an exchange of the communications with a server through the communication module and a means for receiving a request to perform a search within the exchanged communications. In response to a verification of a connection to the server, additional means may be described, such as a means for submitting a remote search request within remotely stored communications based on the received request to the server, a means for initiating the local search within locally stored communications, and a means for displaying search results through a communication interlace. The search results may be based on the remote search request and/or the local search.

According to other embodiments, computing devices for identifying search results from a local and remote search of communications may be described. An example computing device may include a communication module, a memory and processors coupled to the memory and the communication module. The processors may execute a communication application in conjunction with instructions stored in the memory. The communication application may include a processing engine and a search engine. The processing engine may be configured to, at least, facilitate an exchange of the communications with a server through the communication module. The search engine may be configured to receive at request to perform a search within the exchanged communications. The search engine may also be configured to, in response to a verification of a connection to the server, submit a remote search request within remotely stored communications based on the received request to the server, initiate the local search within locally stored communications, and display search results through a communication interface. The search results may be based on the remote search request and/or the local search.

According to additional examples, the search engine may be further configured to receive a selection of the search results. The search engine may also display the communications associated with the selected search results through the communication interface. The search results include may include a calendar invite, a personal email address of a participant, a professional email address of the participant, an attachment, a task item, a group conversation thread, and/or a folder.

According to other embodiments, the search engine may be further configured to identify attributes associated with the search results. The attributes may include a priority, a subject matter, and/or a time stamp. The search engine may also display the attributes through the communication interface and employ a textual scheme, a coloring scheme, a shading scheme, and/or a graphical element to distinguish the attributes from the search results.

According to sonic examples, the search engine may be further configured to receive a refinement request, from a participant, to modify the search results and may identify a credential associated with the participant. The search engine may compare the credential to a predefined rule. The search engine may also detect a match between the credential and the predefined rule.

According to other examples, the search engine may be further configured to submit another remote search request within the remotely stored communications based on the refinement request, initiate another local search within the locally stored communications, replace the search results with a new set of search results, and display the new set of search results through the communication interface. In other examples, the search engine may be further configured to detect a mismatch between the credential and the predefined rule and display a notification through the communication interface to the participant of a failure to initiate another remote search request within the remotely stored communications and a failure to initiate another local search within the locally stored communications.

According to some examples, the search engine may be further configured to detect a failure to connect to the server, prevent an initiation of the remote search request within the remotely stored communications based on the received request to the server, and display the search results through the communication interface. The search results may be based on the local search. The search engine may also receive a selection of the search results and may display the communications associated with the selected, search results through the communication interface.

According to other examples, methods executed on computing devices for identifying search results from a local and remote search of communications in parallel may be described. An example method may include receiving a request to perform a search of the communications, verifying a connection a server, submitting a remote search request within remotely stored communications based on the received request to the server, initiating the local search within locally stored communications, and displaying search results. The search results may be based on the remote search request and the local search. The search results may include a calendar invite, a personal email address of a participant, a professional email address of the participant, an attachment, a task item, a group conversation thread, and/or a folder.

According to other examples, the method may further include detecting a failure to connect to the server, preventing an initiation of the remote search request within the remotely stored communications based on the received request to the server, and implementing an intelligent learning algorithm to: identify a previous search of the locally stored communications. The previous search may share a keyword, a syntax modifier, and/or a portion of the keyword with the local search and identify previous search results associated with the previous search. The method may also include displaying the previous search results with the search results.

According to some embodiments, the previous search results include a calendar invite, an attachment, a personal email address of a participant, a professional email address of the participant, a task item, a group conversation thread, and/or a folder. According to other embodiments, the method may further include identifying a first time stamp attribute associated with the search results and a second time stamp attribute associated with the previous search results and ordering the search results associated with the first time stamp attribute and the previous search results associated with the second time stamp attribute in an ascending chronological order or a descending chronological order.

According to additional embodiments, the method may further include identifying attributes associated with local search results and attributes associated with remote search results and identifying a first priority attribute associated with the local search results and a second priority attribute associated with remote search results. The attributes may include a priority, a subject matter, and a time stamp. The method may further include assigning a first weighted value to the first priority attribute and a second weighed value to the second priority attribute and comparing the first weighted value to the second weighed value. In some examples, the method may detect the first weighted value as being greater than the second weighted value, may order the local search results prior to the remote search results, and may display the ordered local search results and the ordered remote search results. In other examples, the method may detect the second weighted value as being greater than the first weighted value, may order the remote search results prior to the local search results, and may display the ordered local search results and the ordered remote search results.

According to some examples, computer-readable storage devices with instructions stored thereon for identifying search results from a local and remote search of communications in parallel may be provided. The instructions may include receiving a request to perform a search of the communications, verifying a connection to a server, submitting a remote search request within remotely stored communications based on the received request to the server, initiating the local search within locally stored communications, and displaying search results. The search results may be based on the remote search request and the local search. The search results may include a calendar invite, a personal email address of a participant or a group, a professional email address of the participant or the group, an attachment, a task item, a group conversation thread, and/or a folder.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device for identifying search results from a local and remote search of communications, the computing device comprising:
a communication module;
a memory; and
one or note processors coupled to the memory and the communication module, the one or more processors executing a communication application in conjunction with instructions stored in the memory_{;} Wherein the communication application includes:
a processing engine configured to:
facilitate an exchange of the communications with a server through the communication module; and
a search engine configured to:
receive a request to perform a search within the exchanged communications; and
in response to a verification of a connection to the server,
submit a remote search request within remotely stored communications based on the received request to the server;
initiate the local search within locally stored communications; and
display search results through a communication interface, wherein the search results are based on one or more of the remote search request and the local search.

2. The computing device of claim 1, wherein the search engine is further configured to:
receive a selection of one or more of the search results; and
display the communications associated with the selected one or more search results through the communication interface.

3. The computing device of claim 1, wherein the search results include one or more of a calendar invite, a personal email address of a participant, a professional email address of the participant, an attachment, a task item, a group conversation thread, and a folder.

4. The computing device of claim 1, wherein the search engine is further configured to:
identify attributes associated with the search results, wherein the attributes include one or more of a priority, a subject matter, and a time stamp;
display the attributes through the communication interface; and
employ one or more of: a textual scheme, a coloring scheme, a shading scheme, and a graphical element to distinguish the attributes from the search results.

5. The computing device of claim 1, wherein the search engine is further configured to:
receive a refinement request, from a participant, to modify the search results;
identify a credential associated with the participant; and
compare the credential to a predefined rule.

6. The computing device of claim 5, wherein the search engine is further configured to:
detect a match between the credential and the predefined rule;
submit another remote search request within the remotely stored communications based on the refinement request;
initiate another local search within the locally stored communications;
replace the search results with a new set of search results:, and
display the new set of search results through the communication interface,

7. The computing device of claim 5, wherein the search engine is further configured to:
detect a mismatch between the credential and the predefined rule; and
display a notification through the communication interface to the participant of a failure to initiate another remote search request within the remotely stored communications and a failure to initiate another local search within the locally stored communications.

8. The computing device of claim 1, wherein the search engine is further configured to:
detect a failure to connect to the server;
prevent an initiation of the remote search request within the remotely stored communications based on the received request to the server; and
display the search results through the communication interface, wherein the search results are based on the local search.

9. The computing device of claim 8, wherein the search engine is further configured to:
receive a selection of one or more of the search results; and
display the communications associated with the selected one or more search results through the communication interface.

10. A method executed on a computing device for identifying search results from a local and remote search of communications in parallel, the method comprising:
receiving a request to perform a search of the communications;
verifying a connection to a server;
submitting a remote search request within remotely stored communications based on the received request to the server;
initiating the local search within locally stored communications; and
displaying, search results,
wherein the search results are based on one or more of the remote search request and the local search, and
wherein the search results include one or more of: a calendar invite, a personal entail address of a participant, a professional email address of the participant, an attachment, a task item, a group conversation thread, and a folder.

11. The method of claim 10, further comprising:
detecting a failure to connect to the server;
preventing an initiation of the remote search request within the remotely stored communications based on the received request to the server;
implementing an intelligent learning algorithm to:
identify a previous search of the locally stored communications, wherein the previous search shares one or more of a keyword, a syntax modifier, and a portion of the keyword with the local search; and
identify previous search results associated with the previous search; and
displaying the previous search results with the search results.

12. The method of claim 11, wherein the previous search results include one or more of a calendar invite, an attachment, a personal email address of a participant, a professional email address of the participant, a task item, a group conversation thread, and a folder.

13. The method of claim 11, further comprising:
identifying a first time stamp attribute associated with the search results and a second time stamp attribute associated with the previous search results; and
ordering the search results associated with the first time stamp attribute and the previous search results associated with the second time stamp attribute in one or more of an ascending chronological order and a descending chronological order.

14. The method of claim 10, further comprising:
identifying attributes associated with local search results and attributes associated with remote search results, wherein the attributes include one or more of a priority, a subject matter, and a time stamp; and
identifying a first priority attribute associated with the local search results and a second priority attribute associated with remote search results.

15. The method of claim 14, further comprising:
assigning a first weighted value to the first priority attribute and a second weighed value to the second priority attribute; and
comparing the first weighted value to the second weighed value.

16. The method of claim 15, further comprising:
detecting the first weighted value as being greater than the second weighted value;
ordering the local search results prior to the remote search results; and
displaying the ordered local search results and the ordered remote search results.

17. The method of claim 15, further comprising:
detecting the second weighted value as being greater than the first weighted value;
ordering the remote search results prior to the local search results; and
displaying the ordered local search results and the ordered remote search results.

18. A computer-readable storage device with instructions stored thereon for identifying search results from a local and remote search of communications in parallel, the instructions comprising:
receiving a request to perform a search of the communications;
verifying a connection to a server;
submitting a remote search request within remotely stored communications based on the received request to the server;
initiating the local search within locally stored communications; and
displaying search results,
wherein the search results are based on one or more of the remote search request and the local search, and
wherein the search results include one or more of a calendar invite, a personal email address of a participant or a group, a professional email address of the participant or the group, an attachment, a task item, a group conversation thread, and a folder.

19. The computer-readable storage device of claim 18, wherein the instructions further comprise:
identifying attributes associated with local search results and attributes associated with remote search results, wherein the attributes include one or more of a priority, a subject matter, and a time stamp;
identifying a first priority attribute associated with the local search results and a second priority attribute associated with remote search results;
assigning a first weighted value to the first priority attribute and a second weighed value to the second priority attribute; and
comparing the first weighted value to the second weighed value.

20. The computer-readable storage device of claim 19, wherein the instructions further comprise:
detecting the first weighted value as being greater than the second weighted value;
ordering the local search results prior to the remote search results; and
presenting the ordered local search results and the ordered remote search results.
